(19) United States
(12) Patent Application Publication
(10) Pub. No.: US 2014/0293511 A1
(43) Pub. Date: Oct. 2, 2014

(54) ELECTRIC STORAGE DEVICE

(71) Applicant: MURATA MANUFACTURING CO., LTD, Nagaokakyo-Shi (JP)

(72) Inventors: Atsutaka Mori, Nagaokakyo-Shi (JP); Katsuhiko Morita, Nagaokakyo-Shi (JP); Tadahiro Minamikawa, Nagaokakyo-Shi (JP); Eiji Konishi, Nagaokakyo-Shi (JP)

(21) Appl. No.: 14/306,804

(22) Filed: Jun. 17, 2014

Related U.S. Application Data
(63) Continuation of application No. PCT/JP2012/081619, filed on Dec. 6, 2012.

(30) Foreign Application Priority Data
Dec. 22, 2011 (JP) 2011-282021

(51) Int. Cl. H01G 11/26

(52) U.S. Cl. CPC H01G 11/26
USPC 361/502

(57) ABSTRACT

A device main body includes positive electrode layers, negative electrode layers, and separator layers interposed between the positive electrode layers and the negative electrode layers. A package includes a housing-shaped package main body in which the element main body is accommodated, and a package peripheral edge portion which is flat, thinner in thickness than the package main body, and extends continuously from the package main body. A positive and a negative electrode terminals are extended to the outside from the package peripheral edge portion, and respectively include positive and negative electrode folded-back portions that are formed by the extended portions being folded back. The positive and the negative electrode folded-back portions have free ends and in contact with a surface of the package peripheral edge portion.

### CROSS REFERENCE TO RELATED APPLICATIONS

The present application is a continuation of PCT/JP2012/081619 filed Dec. 6, 2012, which claims priority to Japanese Patent Application No. 2011-282021, filed Dec. 22, 2011, the entire contents of each of which are incorporated herein by reference.

### FIELD OF THE INVENTION

The present invention relates to electric storage devices, specifically relates to electric storage devices such as electric double-layer capacitors and the like with improved terminal structures.

### BACKGROUND OF THE INVENTION

Along with the widespread use of mobile electronic apparatuses such as cellular phones, notebook computers, digital cameras, and so on, a variety of electric storage devices such as electric double-layer capacitors, lithium-ion capacitors, lithium-ion secondary batteries, and the like have been actively researched and developed as cordless power sources of such mobile electronic apparatuses.

Recently, the above-mentioned electric storage devices have drawn considerable attention, particularly as batteries for further improved convenience of the mobile electronic apparatuses and also as on-vehicle batteries of electric cars, hybrid vehicles, and so on. Accordingly, electric storage devices having high energy density, capable of supplying high output, and having a long lifetime are strongly expected to be provided.

In Patent Document 1, an electrochemical device (electric storage device) using a laminate film exterior member is proposed; in the electrochemical device, inner surfaces of a laminate film are bonded to each other and part of the laminate film joint portion is disposed on an upper plane surface of the laminate film exterior member.

FIG. 11 is a perspective view of the electrochemical device described in Patent Document 1, and FIG. 12 is a cross-sectional view when viewed along arrows a-a in FIG. 11.

This electrochemical device includes a device element main body 101, a lead terminal 107 connected to the device element main body 101 at a connecting portion 109, and a laminate film exterior member 104 in which the device element main body 101 is accommodated. A laminate film joint portion 103 is disposed on an upper plane surface 102 of the laminate film exterior member 104, and an end portion 108 and an end portion 106 are joined to each other at the laminate film joint portion 103. The end portion 108 is an end portion of the laminate film exterior member 104 that is folded back at the upper plane surface 102 side. The end portion 106 is an end portion of the laminate film exterior member 104 that is folded back from an end surface 105 of the laminate film exterior member 104 at the connecting portion 109 side. The lead terminal 107 is extended from the laminate film joint portion 103 to the outside of the laminate film exterior member 104 so as to form an extended portion 107a; the extended portion 107a is extended above the upper plane surface 102.

That is to say, in Patent Document 1, the laminate film exterior member 104 is bent back on the upper plane surface 102 so that the inner surfaces thereof are joined to each other, and the lead terminal 107 is extended from the laminate film bonding portion 103.
Patent Document 1: Japanese Unexamined Patent Application Publication No. 2002-260601 (claim 1, FIGS. 1 and 2)

However, in Patent Document 1, although the extended portion 107a of the lead terminal 107 is disposed above the upper plane surface 102 without being projected to the outside from an end surface of the device element main body 101 so as to reduce the size of the device, a thickness “t” of the device is increased because the laminate film joint portion 103 where the end portions of the laminate film exterior member 104 are folded back and joined together is located on the upper plane surface 102. Accordingly, the height of the device cannot be sufficiently reduced.

### SUMMARY OF THE INVENTION

Taking into consideration the above problematic situation, the present invention aims to provide an electric storage device that is small in size, easy to be mounted, and capable of being manufactured at excellent productivity.

In order to achieve the above goal, an electric storage device according to the present invention includes an element main body in which electrode layers and insulation layers are alternately laminated or wound, a package in which the element main body is accommodated, and a plurality of terminals electrically connected with the element main body. In the electric storage device, at least one of the plurality of terminals has an extended portion that is extended to the outside of the package and folded back to form a folded-back portion, and the folded-back portion has a free end disposed on a surface of the package.

Accordingly, an increase in thickness of the device is suppressed and the size of the device can be reduced.

In the electric storage device of the present invention, it is preferable that the package include a package main body having therein the element main body, and a peripheral edge portion which is thinner in thickness than the package main body and extends continuously from the package main body, and that at least part of the folded-back portion be disposed in a location which is on a surface of the peripheral edge portion and is lower in height than the package main body.

Accordingly, the height of the folded-back portion can be reduced, thereby making it possible for the electric storage device to be smaller in height. Therefore, it is possible to suppress contact between other components and the folded-back portion in the manufacturing process and suppress variations in shape, location, or the like of the folded-back portion.

In the electric storage device of the present invention, it is preferable that the plurality of terminals be extended from the same end surface of the peripheral edge portion to the outside, folded back, and disposed in parallell, or juxtaposed, or aligned on the peripheral edge portion.

This makes it possible to mount the device using a socket. Accordingly, it is unnecessary to mount the device using paste such as solder or the like, whereby productivity can be enhanced.

In the electric storage device of the present invention, it is preferable that a lateral side of the peripheral edge portion be folded back to form a lateral side folded-back portion.

That is to say, the lateral side of the peripheral edge portion is folded back to form the lateral side folded-back portion, which enhances strength of the package. Accordingly, strength of the terminals disposed on the peripheral edge portion is also enhanced so that an electric storage device suitable for mounting using a socket can be realized.

In the electric storage device of the present invention, it is preferable that the folded-back portion be in contact with the package.

By causing the folded-back portion to be in contact with the package as described above, the folded-back portion is supported by the package, whereby the strength of the terminals is enhanced and an electric storage device that is suitable for mounting using a socket can be obtained.

In the electric storage device of the present invention, it is preferable that an external connecting terminal be formed on a surface of the folded-back portion, and part of the external connecting terminal be located outside of a package region.

In this case, solder-mounting can be carried out with ease by welding solder to the external connecting terminal. In addition, because part of the external connecting terminal is located outside of the package region, a bonding area for solder-mounting becomes large so that strongly secured bonding can be achieved. Furthermore, a solder bonding state can be easily confirmed by causing solder to wet and cover the external connecting terminal that is projected to the outside region.

In the electric storage device of the present invention, it is preferable that an external connecting terminal be formed on a surface of the folded-back portion, and part of the external connecting terminal be bent back in a state of extending along the surface of the folded-back portion.

In this case, because the bent-back portion of the external connecting terminal is exposed to the lateral side, it is possible to carry out soldering with ease and to confirm the solder bonding state also with ease.

Further, it is preferable that the electric storage device of the present invention be mounted on a substrate.

In this case, by providing a socket on the substrate, the electric storage device can be mounted on the substrate with ease using the socket. This makes it unnecessary to mount the electric storage device using solder, which leads to enhancement of the productivity. Further, even in the case of solder-mounting, the mounting can be easily made by placing the electric storage device on the substrate and thereafter carrying out the soldering. Accordingly, it is possible to mount the device in the manner corresponding to each purpose of applications.

According to the above-mentioned electric storage device, there are included an element main body in which electrode layers and insulation layers are alternately laminated or wound, a package in which the element main body is accommodated, and a plurality of terminals electrically connected with the element main body. In the electric storage device, at least one of the plurality of terminals has an extended portion that is extended to the outside of the package and folded back to form a folded-back portion, and the folded-back portion has a free end disposed on a surface of the package, thereby making it possible to suppress an increase in thickness of the device and reduce the size of the device.

### BRIEF DESCRIPTION OF DRAWINGS

FIG. 1 is a perspective view illustrating an embodiment of an electric double-layer capacitor as an electric storage device according to the present invention.

FIG. 2 is a cross-sectional view when viewed along arrows A-A in FIG. 1.

FIG. 3 is a plan view of a main portion when viewed along arrows B-B in FIG. 2.

FIG. 4 illustrates plan views illustrating constituent members of an element main body.

FIG. 5 is a cross-sectional view illustrating an example in which the above-mentioned electric double-layer capacitor is used and mounted on a substrate.

FIG. 6 is a cross-sectional view illustrating another example in which the above-mentioned electric double-layer capacitor is used and mounted on a substrate.

FIG. 7 is a cross-sectional view illustrating a first variation on the above embodiment.

FIG. 8 is a cross-sectional view illustrating an example in which the first variation is used and mounted on a substrate.

FIG. 9 is a cross-sectional view illustrating a second variation on the above embodiment.

FIG. 10 is a cross-sectional view illustrating an example in which the above embodiment is used and mounted on a substrate.

FIG. 11 is a perspective view illustrating an example of the existing electrochemical device described in Patent Document 1.

FIG. 12 is a cross-sectional view when viewed along arrows a-a in FIG. 11.

### PREFERRED DESCRIPTION OF THE DETAILED EMBODIMENTS

Next, embodiments of the present invention will be described in detail with reference to the drawings.

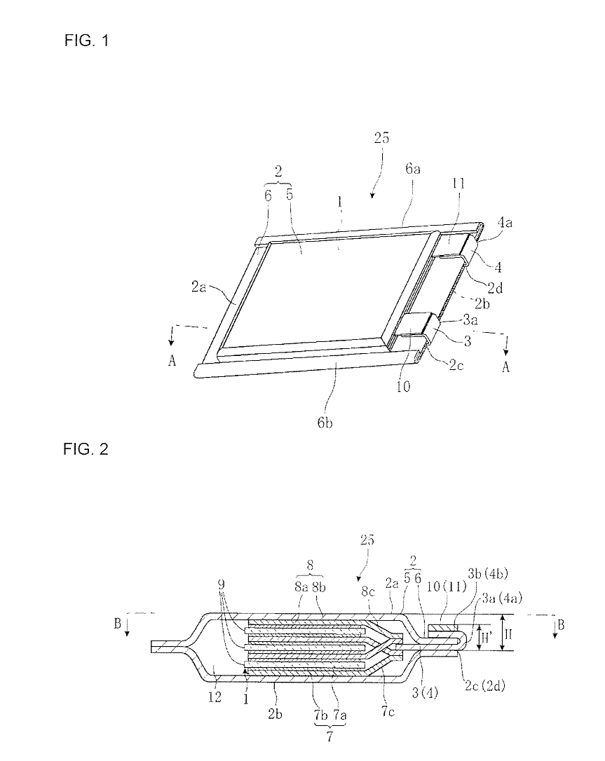

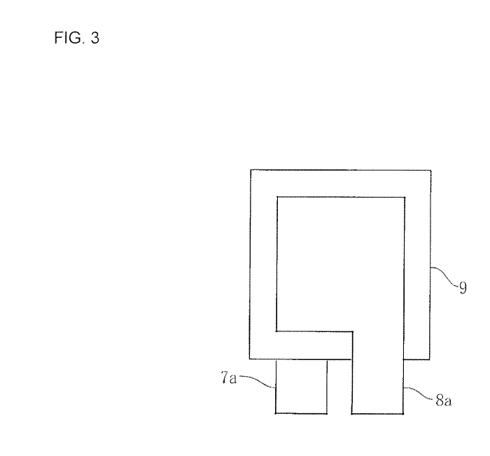

FIG. 1 is a perspective view illustrating an embodiment (first embodiment) of an electric double-layer capacitor as an electric storage device according to the present invention. FIG. 2 is a cross-sectional view when viewed along arrows A-A in FIG. 1. FIG. 3 is a plan view of a main portion when viewed along arrows B-B in FIG. 2.

An electric double-layer capacitor 25 includes an element main body 1, a package 2 in which the element main body 1 is accommodated, and a positive electrode terminal 3 and a negative electrode terminal 4 that are electrically connected with the element main body 1 and extended to the outside from the package 2.

In the package 2, an upper package 2a and a lower package 2b are integrally formed through thermal fusion bonding using polypropylene or the like, and a positive electrode terminal extended portion 2c and a negative electrode terminal extended portion 2d are formed in a sealed state so that the positive electrode terminal 3 and the negative electrode terminal 4 can be extended to the outside from the package 2. Further, the outer surface of the package 2 is covered with a thin film made of nylon or the like, the inner surface of the package 2 is covered with a thin film made of polypropylene or the like, and the package 2 and the element main body 1 are electrically insulated from each other.

To be more specific, the package 2 includes a housing-shaped package main body 5, and a package peripheral edge portion 6 which is flat, thinner in thickness than the package main body 5, and extends continuously from the package main body 5. The positive electrode terminal extended portion 2c and the negative electrode terminal extended portion 2d are provided at predetermined locations on one end surface of the package peripheral edge portion 6.

Both lateral sides of the package peripheral edge portion 6 are folded back to form a lateral side folded-back portion 6a and a lateral side folded-back portion 6b.

The element main body 1 includes, as shown in FIG. 2, a plurality of positive electrode layers (electrode layers) 7, a plurality of negative electrode layers (electrode layers) 8, and separator layers (insulation layers) 9 each interposed between the positive electrode layers 7 and the negative electrode layers 8.

In the positive electrode layer 7, a positive-electrode active material layer 7b is formed on one main surface or both main surfaces of a positive-electrode collector layer 7a. In the negative electrode layer 8, a negative-electrode active material layer 8b is formed on one main surface or both main surfaces of a negative-electrode collector layer 8a.

The positive electrode terminal 3 and the negative electrode terminal 4 are extended from one end portion of the package peripheral edge portion 6, and these extended portions are folded back to form a positive electrode folded-back portion 3a and a negative electrode folded-back portion 4a, respectively. In other words, the positive electrode terminal 3 and the negative electrode terminal 4 are provided in parallel on the package peripheral edge portion 6. The positive electrode folded-back portion 3a and the negative electrode folded-back portion 4a are in contact with the package peripheral edge portion 6 without being affixed thereto.

As described above, both the positive electrode folded-back portion 3a and the negative electrode folded-back portion 4a have free ends.

Further, the positive electrode folded-back portion 3a and the negative electrode folded-back portion 4a are each disposed at a position which is on a surface of the package peripheral edge portion 6 and is lower in height than the package main body 5. In other words, the positive electrode folded-back portion 3a and the negative electrode folded-back portion 4a are each disposed at a position which is on the surface of the package peripheral edge portion 6, and at which the total height of the positive electrode folded-back portion 3a and a positive electrode-side external connecting terminal 10 or the total height of the negative electrode folded-back portion 4a and a negative electrode-side external connecting terminal 11, that is, a height H′ shown in FIG. 2 is lower than a height H from the aforementioned extended portion of the package main body 5.

The positive electrode-side external connecting terminal 10 and the negative electrode-side external connecting terminal 11 made of Cu or the like are respectively formed on planar portions 3b and 4b of the positive electrode terminal 3 and the negative electrode terminal 4.

More specifically, as illustrated in FIG. 3, the positive electrode layer 7 and the negative electrode layer 8 are stacked with the separator 9 interposed therebetween so that both the positive-electrode collector layer 7a and the negative-electrode collector layer 8a can be respectively connected with the positive electrode terminal 3 and the negative electrode terminal 4 at one end surface side.

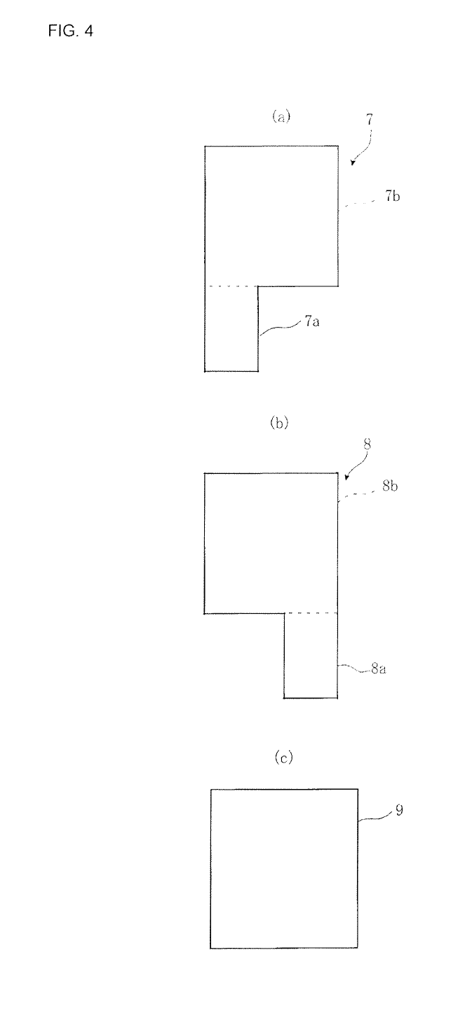

In other words, in the positive electrode layer 7, as shown in FIG. 4(a), the positive-electrode active material layer 7b is formed in a rectangular shape, and the positive-electrode collector layer 7a is disposed on a surface of the positive-electrode active material layer 7b in a state in which the positive-electrode collector layer 7a covers the entirety of the positive-electrode active material layer 7b and one end thereof protrudes from the positive-electrode active material layer 7b.

In the negative electrode layer 8, as shown in FIG. 4(b), the negative-electrode active material layer 8b is formed in a rectangular shape, and is disposed on a surface of the negative-electrode collector layer 8a in a state in which the negative-electrode active material layer 8b is formed symmetrical to the positive-electrode active material layer 7b.

The separator 9, as shown in FIG. 4(c), is formed to have a predetermined area which is slightly larger in size than the positive-electrode active material layer 7b and the negative-electrode active material layer 8b.

The positive electrode layer 7, the separator 9, and the negative electrode layer 8 are stacked in a predetermined order a plurality of times. In other words, the plurality of positive electrode layers 7, the plurality of separators 9, and the plurality of negative electrode layers 8 are sequentially stacked in the order of one electrode layer (positive electrode layer 7 or negative electrode layer 8), the separator layer 9, the other electrode layer which forms the opposite electrode to the electrode of the one electrode layer (negative electrode layer 8 or positive electrode layer 7), and the separator layer 9, whereby the element main body 1 is formed.

One end 7c of the positive-electrode collector layer 7a is electrically connected with the positive electrode terminal 3, while one end 8c of the negative-electrode collector layer 8a is electrically connected with the negative electrode terminal 4.

The element main body 1, part of the positive electrode terminal 3, and part of the negative electrode terminal 4 are confined, together with an electrolyte 12, to the inside of the package main body 5, and tip ends of the positive electrode terminal 3 and the negative electrode terminal 4 are respectively extended to the outside from the package peripheral edge portion 6. These extended portions are folded back to form the folded-back portions 3a and 4a, respectively.

Materials to be used in forming the positive-electrode collector 7a, the negative-electrode collector 8a, the positive-electrode active material layer 7b, and the negative-electrode active material layer 7b are not limited to any specific ones, that is, any materials can be used as long as they exhibit required effects as the electric double-layer capacitor. In general, aluminum is used for the positive-electrode collector layer 7a and the negative-electrode collector layer 8a, and activated carbon is used for the positive-electrode active material layer 7b and the negative-electrode active material layer 8b.

Types of material to be used in forming the separator 9 are not limited to any specific ones, and porous polyethylene can be used, for example.

Materials to be used in forming the electrolyte 12 are also not limited to any specific ones, that is, any materials can be used as long as they exhibit required effects. In general, a material containing propylene carbonate as a solvent and tetrafluoroborate tetraethylammonium as an electrolyte can be preferably used.

Materials to be used in forming the package 2, the positive electrode terminal 3, and the negative electrode terminal 4 are also not limited to any specific ones; in general, aluminum is preferably used.

Next, a method for manufacturing the electric double-layer capacitor 25 will be described in detail.

First, manufactured are the positive electrode layer 7 in which the positive-electrode active material 7b is formed on one main surface or both main surfaces of the positive-electrode collector 7a, and the negative electrode layer 8 in which the negative-electrode active material 8b is formed on one main surface or both main surfaces of the negative-electrode collector 8a.

Then, the positive electrode layers 7 and the negative electrode layers 8 are sequentially stacked with the separators 9 interposed therebetween, thereby manufacturing the element main body 1.

Next, the one end 7c of the positive-electrode collector 7a is bonded to the positive electrode terminal 3 by welding or the like, and the one end 8c of the negative-electrode collector 8a is bonded to the negative electrode terminal 4 by welding or the like.

Subsequently, the element main body 1, part of the positive electrode terminal 3, and part of the negative electrode terminal 4 are accommodated, together with the electrolyte 12, in the package 2 formed in a predetermined shape; the upper package 2a and the lower package 2b are made to be in contact with each other and then bonded to each other using polypropylene through thermal fusion bonding; and the element main body 1 is confined to the inside of the package main body 5.

Next, the lateral sides of the package peripheral edge portion 6 are folded back to form the lateral side folded-back portions 6a and 6b.

Subsequently, the positive electrode-side external connecting terminal 10 and the negative electrode-side external connecting terminal 11 made of Cu or the like are respectively bonded to the planar portions 3b and 4b of the positive electrode terminal 3 and the negative electrode terminal 4 by ultrasonic welding or the like. Thereafter, the positive electrode terminal 3 and the negative electrode terminal 4 are folded back in one direction to form the positive electrode folded-back portion 3a and the negative electrode folded-back portion 4a, which completes the manufacture of the electric double-layer capacitor.

In this embodiment, as described thus far, the positive electrode terminal 3 and the negative electrode terminal 4 are extended to the outside of the package 2. The extended portions are respectively folded back to form the positive electrode folded-back portion 3a and the negative electrode folded-back portion 4a, and the positive electrode folded-back portion 3a and the negative electrode folded-back portion 4a have free ends disposed on the surface of the package 2. This makes it possible to suppress an increase in thickness of the device and reduce the size of the device.

Because the tip end of the positive electrode terminal 3 and the tip end of the negative electrode terminal 4 are disposed within a region of the package 2, it is possible to suppress contact between other components and the positive electrode terminal 3 and the negative electrode terminal 4 in the manufacturing process and suppress variations in the shape or location of the positive electrode terminal 3 and the negative electrode terminal 4. Accordingly, location adjustment of the device when it is mounted on a substrate can be carried out with ease and the occurrence of mounting failure in the manufacturing process can be suppressed, whereby productivity can be enhanced.

The positive electrode folded-back portion 3a and the negative electrode folded-back portion 4a are each disposed at a position which is on the surface of the package peripheral edge portion 6, and at which the total height of the positive electrode folded-back portion 3a and the positive electrode-side external connecting terminal 10 or the total height of the negative electrode folded-back portion 4a and the negative electrode-side external connecting terminal 11, that is, the height H′ shown in FIG. 2 is lower than the height H from the aforementioned extended portion of the package main body 5. Accordingly, the positive electrode folded-back portion 3a and the negative electrode folded-back portion 4a can be lowered in height. Through this, it possible to suppress contact between other components and the positive electrode folded-back portion 3a, the negative electrode folded-back portion 4a, the positive electrode-side external connecting terminal 10 and/or the negative electrode-side external connecting terminal 11 in the manufacturing process, and to suppress variations in the shape or location of the positive electrode folded-back portion 3a and the negative electrode folded-back portion 4a.

In addition, the electric storage device can be lowered in height by disposing the positive electrode folded-back portion 3a and the negative electrode folded-back portion 4a at positions where the respective heights thereof are lower than the height of the package main body 5 as described above.

Because the positive electrode terminal 3 and the negative electrode terminal 4 are provided in parallel on the package peripheral edge portion 6, the electric storage device can be mounted by inserting the end portion thereof into the socket. This makes it unnecessary to mount the device using paste such as solder, whereby productivity can be enhanced.

Because the positive electrode folded-back portion 3a and the negative electrode folded-back portion 4a are in contact with the surface of the package peripheral edge portion 6, the positive electrode folded-back portion 3a and the negative electrode folded-back portion 4a can be supported by the package peripheral edge portion 6. This makes it possible to obtain an electric storage device suitable for mounting using a socket.

Because the lateral sides of the package peripheral edge portion 6 are folded back so as to respectively form the lateral side folded-back portions 6a and 6b, strength of the package 2 is enhanced. Accordingly, strength of the positive electrode terminal 3 and the negative electrode terminal 4 disposed on the package peripheral edge portion 6 is also enhanced, thereby making it possible to provide an electric storage device suitable for mounting using a socket.

Because the external connecting terminals 10 and 11 are respectively formed on the planar portions 3b and 4b of the positive electrode folded-back portion 3a and the negative electrode folded-back portion 4a, solder-mounting can be carried out with ease by welding solder to the external connecting terminals 10 and 11.

As described thus far, according to this embodiment, the device can be mounted using a socket, which makes solder-mounting unnecessary; further, even in the case of solder-mounting, an electric storage device that can be easily mounted by soldering can be obtained.

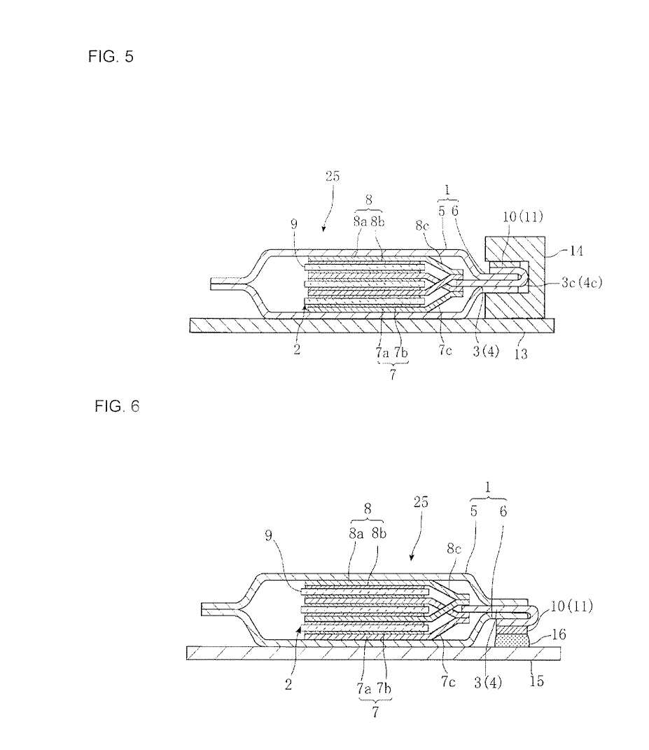

FIG. 5 is a cross-sectional view illustrating an example of the electric double-layer capacitor being mounted on a substrate.

That is, a socket 14 is provided on a substrate 13. The positive electrode terminal 3 and the negative electrode terminal 4, on the surfaces of which the external connecting terminals 10 and 11 are respectively formed, can be inserted and mounted to the socket 14 in a detachable manner.

As described above, in this embodiment, the mounting can be carried out by inserting the positive electrode terminal 3 and the negative electrode terminal 4 of the electric double-layer capacitor 25 into the socket 14. This makes it unnecessary to mount the device using paste such as solder, whereby the productivity can be enhanced.

FIG. 6 is a cross-sectional view illustrating another example of the electric double-layer capacitor being mounted on a substrate.

That is, the electric double-layer capacitor 25 is placed and mounted on a substrate 15 through solder-mounting using solder 16.

In this embodiment, as described above, the device can also be mounted by welding the solder 16 to the external connecting terminals 10 and 11 of the electric double-layer capacitor 25, which makes it possible to mount the device in the manner corresponding to each purpose of applications.

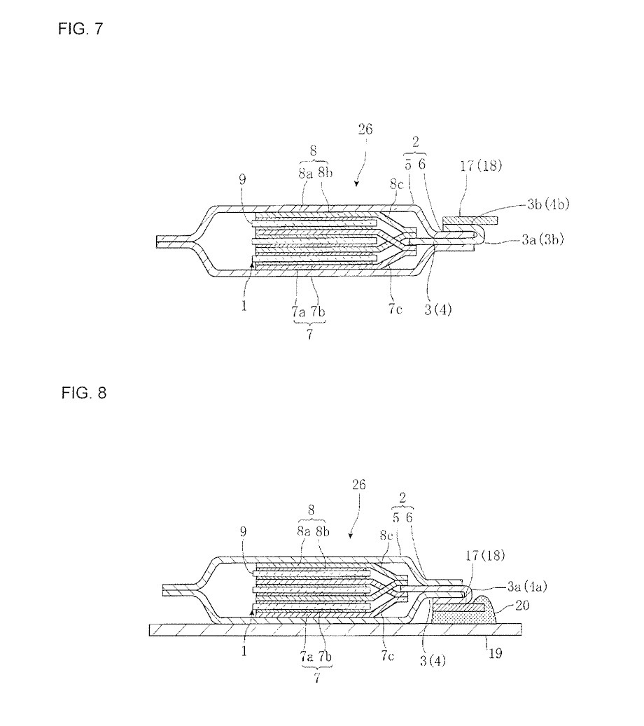

FIG. 7 is a cross-sectional view illustrating a first variation on the above embodiment.

That is, in an electric double-layer capacitor 26, external connecting terminals 17 and 18 are respectively formed on the planar portions 3b and 4b of the positive electrode terminal 3 and the negative electrode terminal 4 so that part of the external connecting terminal 17 and part of the external connecting terminal 18 are located outside of the region of the package 2.

FIG. 8 is a cross-sectional view illustrating an example in which the electric double-layer capacitor 26 of the first variation is used and mounted on a substrate.

That is, with respect to the electric double-layer capacitor 26 placed on a substrate 19, solder 20 is welded to the external connecting terminals 17 and 18 that are located in the outside region of the package 2.

In the first variation, as described above, because part of the external connecting terminal 17 and part of the external connecting terminal 18 are located in the outside region of the package 2, bonding areas for solder-mounting become large, whereby strongly secured bonding can be achieved.

Furthermore, by causing solder to wet and cover the external connecting terminals 17 and 18 that are projected to the outside region, the bonding state with the solder 20 can be easily confirmed.

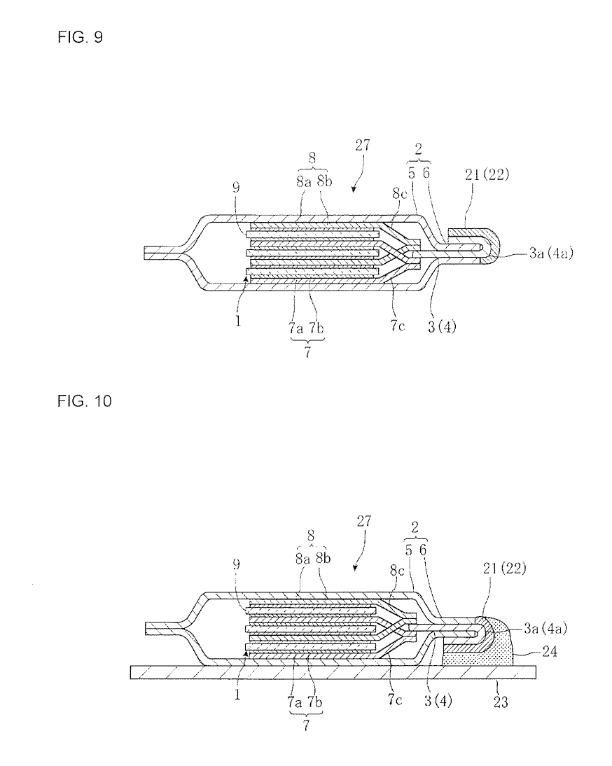

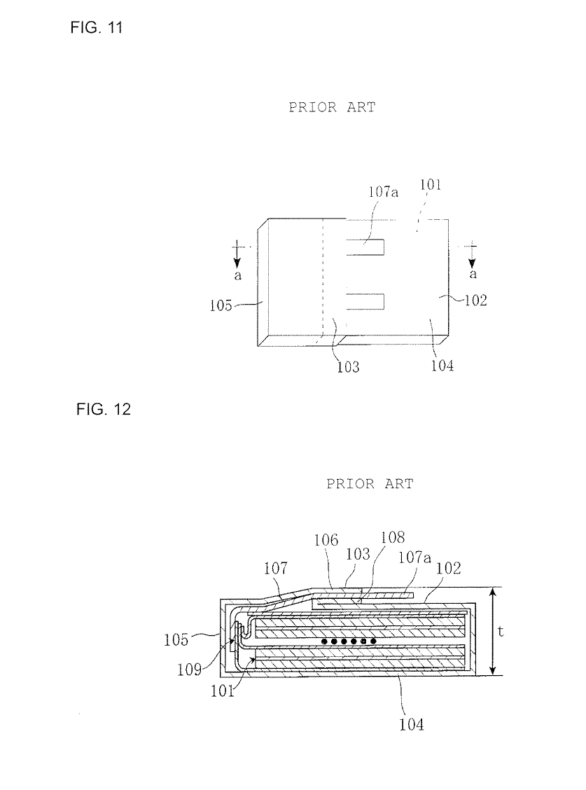

FIG. 9 is a cross-sectional view illustrating a second variation on the above embodiment.

That is, in an electric double-layer capacitor 27, external connecting terminals 21 and 22 are formed in a state in which part of the external connecting terminal 21 and part of the external connecting terminal 22 are folded back along the respective outer surfaces of the folded-back portions 3a and 4a.

FIG. 10 is a cross-sectional view illustrating an example in which the electric double-layer capacitor of the second variation is used and mounted on a substrate.

That is, the electric double-layer capacitor 27 placed on a substrate 23 is solder-mounted.

In the second variation, because part of the external connecting terminal 21 and part of the external connecting terminal 22 are folded back along the respective outer surfaces of the folded-back portions 3a and 4a of the positive electrode terminal 3 and the negative electrode terminal 4, bent-back portions of the external connecting terminals 21 and 22 are respectively exposed to the lateral side. This makes it easy to carry out soldering and makes it possible to easily confirm the bonding state with solder 24.

Note that the present invention is not intended to be limited to the above embodiments. In the above embodiments, the positive electrode folded-back portion 3a and the negative electrode folded-back portion 4a are in contact with the surface of the package peripheral edge portion 6. However, it is only necessary for the positive electrode folded-back portion 3a and the negative electrode folded-back portion 4a to have free ends disposed on the surface of the package 2, and there may be slight gaps between the package 2 and the positive electrode folded-back portion 3a and between the package 2 and the negative electrode folded-back portion 4a.

In the above embodiments, the element main body 1 has a stacked structure in which the electrode layer (positive electrode layer 7 or negative electrode layer 8) and the separator layer 9 are stacked a plurality of times. However, the element main body 1 may have a winding structure, and the invention can be similarly applied to a case of a single-cell structure in which a single positive electrode layer 7, a single separator layer 9, and a single negative electrode layer 8 are stacked.

Although the case in which two terminals, that is, the positive electrode terminal 3 and the negative electrode terminal 4 are included in the device is discussed in the above embodiments, the invention can be similarly applied to a case in which more than two terminals are included, that is, a voltage adjustment terminal is included in addition to the positive electrode terminal 3 and the negative electrode terminal 4.

Although the electric double-layer capacitor is taken as an example and described in the above embodiments, the invention can be widely applied to other types of electric storage devices such as a lithium-ion secondary battery, a lithium-ion capacitor, and so on.

It is to be noted that materials used in the present invention may be appropriately selected and used from among the existing materials, and a variety of applications and variations can be made on the shapes, specific configurations, and the like of the electric storage devices without departing from the scope and range of the present invention.

### INDUSTRIAL APPLICABILITY

According to the present invention, such an electric storage device can be realized that is small in size, easy to be mounted, and manufactured at excellent productivity.

### REFERENCE SIGNS LIST

1 ELEMENT MAIN BODY
2 PACKAGE
3 POSITIVE ELECTRODE TERMINAL
3a POSITIVE ELECTRODE FOLDED-BACK PORTION
4 NEGATIVE ELECTRODE TERMINAL
4a NEGATIVE ELECTRODE FOLDED-BACK PORTION
5 PACKAGE MAIN BODY
6 PACKAGE PERIPHERAL EDGE PORTION
6a, 6b LATERAL SIDE FOLDED-BACK PORTION
7 POSITIVE ELECTRODE LAYER (ELECTRODE LAYER)
8 NEGATIVE ELECTRODE LAYER (ELECTRODE LAYER)
9 SEPARATOR (INSULATION LAYER)
10, 11, 17, 18, 21, 22 EXTERNAL CONNECTING TERMINAL
13, 15, 19, 23 SUBSTRATE

1. An electric storage device comprising:
a package;
an element main body disposed in the package, the element main body including a plurality of alternating positive and negative electrode layers with insulation layers interposed therebetween; and
a pair of terminals electrically connected to the positive and negative electrode layers, respectively,
wherein at least one of the pair of terminals has an extended portion extending outside the package with a folded back portion disposed on a surface of the package.

2. The electric storage device according to claim 1,
wherein the package includes a main body configured to house the element main body, and a peripheral edge portion that extends continuously from the main body, and
wherein the folded back portion is disposed on a surface of the peripheral edge portion.

3. The electric storage device according to claim 2, wherein the peripheral edge portion is thinner than the main body.

4. The electric storage device according to claim 2, wherein the main body has a planar top surface and a planar bottom surface and the extended portion of the at least one terminal is disposed between planes defined by the planar top surface and the planar bottom surface.

5. The electric storage device according to claim 2, wherein the pair of terminals extend from a same end surface of the peripheral edge portion and are disposed in parallel on the peripheral edge portion.

6. The electric storage device according to claim 2, wherein a lateral side of the peripheral edge portion is folded back to form a lateral side folded-back portion.

7. The electric storage device according to claim 1, wherein the folded back portion is in contact with the package.

8. The electric storage device according to claim 1, further comprising an external connecting terminal disposed on a surface of the extended portion of each of the pair of terminals, and part of the external connecting terminal extends laterally past the extended portion of the pair of terminals, respectively.

9. The electric storage device according to claim 1, further comprising an external connecting terminal disposed on a surface of each of the extended portions of the pair of terminals, and part of each external connecting terminal is bent back to extend along a surface of the folded back portion.

10. The electric storage device according to claim 1, wherein the electric storage device is mounted on a substrate.

11. An electric storage device comprising:
a package having a planar top surface and a planar bottom surface that extend in parallel to each other and define a housing, the planar top and bottom surfaces each having respective side portions that extend towards each other to define a peripheral edge portion of the package;
a plurality of alternating positive and negative electrode layers with insulation layers interposed therebetween disposed in the housing; and
a pair of terminals electrically connected to the positive and negative electrode layers, respectively,
wherein the pair of terminals each extend in a lateral first direction outside the housing and between the top and bottom surfaces, and
wherein the pair of terminals each have a folded back portion that extends in a lateral second direction opposite the first direction and is disposed on a surface of the peripheral edge portion of the package.

12. The electric storage device according to claim 11, wherein the peripheral edge portion extends continuously from a main body of the housing.

13. The electric storage device according to claim 12, wherein the peripheral edge portion is thinner than the main body of the housing.

14. The electric storage device according to claim 12, wherein the end portion of each of the pair of terminals is disposed between planes defined by the planar top surface and the planar bottom surface.

15. The electric storage device according to claim 12, wherein the pair of terminals extend from a same end surface of the peripheral edge portion and are disposed in parallel on the peripheral edge portion.

16. The electric storage device according to claim 12, wherein a lateral side of the peripheral edge portion is folded back to form a lateral side folded-back portion.

17. The electric storage device according to claim 11, wherein each folded-back portion is in contact with the package.

18. The electric storage device according to claim 11, further comprising an external connecting terminal disposed on a surface of the folded back portion of each of the pair of terminals, and part of the external connecting terminal extends laterally past the folded back portion of the pair of terminals, respectively.

19. The electric storage device according to claim 11, further comprising an external connecting terminal disposed on a surface of each of the folded back portions of the pair of terminals, and part of each external connecting terminal is bent back to extend along a surface of the folded back portion.

20. The electric storage device according to claim 11, wherein the electric storage device is mounted on a substrate.
